(19) United States
(12) Patent Application Publication
(10) Pub. No.: US 2019/0342324 A1
(43) Pub. Date: Nov. 7, 2019

(54) COMPUTER VULNERABILITY ASSESSMENT AND REMEDIATION

(71) Applicant: IPKeys Technologies, LLC, Eatontown, NJ (US)

(72) Inventors: Robert M. Nawy, Colts Neck, NJ (US); Arthur Bruno Clomera, Stafford, VA (US); Jeffrey Thomas Bochonok, Stafford, VA (US); Richard Shawn Elliott, Stafford, VA (US); Carter John Schoenberg, Red Bank, NJ (US)

(21) Appl. No.: 16/401,873

(22) Filed: May 2, 2019

Related U.S. Application Data
(60) Provisional application No. 62/665,823, filed on May 2, 2018.

(51) Int. Cl. H04L 29/06; G06F 16/22

(52) U.S. Cl. CPC H04L 63/1433; G06F 16/2228; H04L 63/20

(57) ABSTRACT

Technology for detecting and remediating security vulnerabilities in view of one or more computing policies. An example method may involve receiving environment data of a computing environment, the environment data comprising a configuration value of a computing device in the computing environment; accessing an index data structure derived from a computing policy, wherein the index data structure associates an entry of the computing policy with one or more computing features of the computing environment; determining, by a processing device, whether a security vulnerability exists based on the environment data and the index data structure; and providing feedback regarding the security vulnerability and the computing policy.

### RELATED APPLICATIONS

This application claims the benefit of U.S. Provisional Patent Application No. 62/665,823 filed May 2, 2018, entitled “IPKEYS CYBER LAB AS A SERVICE (IPKeys CLaaS),” which is incorporated by reference herein.

### COPYRIGHT NOTICE

Portions of the disclosure of this patent document may contain material subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### TECHNICAL FIELD

One or more implementations relate generally to analyzing a computing environment and, more specifically, to detecting and remediating security vulnerabilities in a computing environment.

### BACKGROUND

Modern computing environments often include a network of interconnected computing devices that interact with one another to provide one or more computing services. The computing environment may provide the computing services to client devices internal to the network or client devices external to the network. As the computing environments expand and increase in complexity they may include more security vulnerabilities. A security vulnerability may be any weakness in one or more aspects of the computing environment that enable an attacker to compromise the integrity, availability, or confidentiality of the computing environment. The burden of detecting and remediating security vulnerabilities is often placed on IT administrators, who may not have the time, resources, or appropriate subject matter expertise to analyze every aspect of the computing environment.

### BRIEF DESCRIPTION OF THE DRAWINGS

The included drawings are for illustrative purposes and serve to provide examples of possible structures and operations for the disclosed inventive systems, apparatus, methods, and computer-readable storage media. These drawings in no way limit any changes in form and detail that may be made by one skilled in the art without departing from the spirit and scope of the disclosed implementations.

FIG. 1 shows a block diagram of an example computing environment, according to some implementations.

FIG. 2 shows a block diagram of example implementations of components of a computing device according to some implementations.

FIG. 3 is an example graphical user interface, according to some implementations.

FIG. 4 is a flow diagram illustrating an example process of detecting security vulnerabilities, according to some implementations.

FIG. 5 is a flow diagram illustrating another example process of detecting security vulnerabilities, according to some implementations.

FIG. 6 is a diagrammatic representation of a machine in the example form of a computer system to perform one or more of the operations described herein.

FIG. 7 is a flow diagram of an example method according to some implementations.

### DETAILED DESCRIPTION

The technology disclosed herein may include a service for detecting and remediating security vulnerabilities in a computing environment. The security vulnerabilities may affect any aspect of a computing environment and the service may inspect and continuously monitor one or more aspects of the computing environment. The service may determine whether a vulnerability currently exists in the computing environment or whether future activity may introduce a vulnerability into the computing environment. For example, the service may analyze a production environment and also have access to a pre-production environment with code or configurations that are currently being developed or customized. The service may analyze the current, future, or past versions of the computing environment to reduce vulnerabilities and enhance the security of the computing environment.

The service may include one or more customized computing devices that access the computing environment and are configured to analyze and assess the computing environment in view of a computing policy. The computing policy may indicate best practices for reducing the quantity or effects of security vulnerabilities. The computing environment may have any number of computing devices and may include a single computing device or multiple (e.g., hundreds, thousands, etc.) computing devices at a single location or across multiple locations (e.g., distributed data center). The customized computing device may access the computing environment by being physically placed within the computing environment (e.g., placed in a data room) or by being provided virtual access to the computing environment (e.g., via a Virtual Private Network (VPN) connection).

The customized computing device may then analyze the computing environment to discover computing devices and to extract environment data (e.g., configuration data) from the computing environment. The customized computing device may generate a model of the computing environment in view of the extracted environment data and use the model to orchestrate the inspection of one or more of the computing devices and code contributing to the computing environment. The customized computing device may correlate and compare the extracted data, external data, other data, or a combination thereof to resolve or associate extracted data with other types of data. The extracted or correlated data may then be used to determine a security state (e.g., security profile) of the computing environment in view of one or more computing policies and be used to enhance the security of the computing environment to comply with the computing policies.

In one example, the computing device may correlate the data using an index data structure that corresponds to a particular computing policy. The index data structure may associate entries of the computing policy (e.g., policy requirements) with particular computing features of a computing environment. For example, a computing policy may include an entry that requires passwords have a minimum complexity (e.g., character length) and the index data structure may indicate computing features that correspond to this requirement (e.g., domain account passwords, root passwords, BIOS passwords). The index data structure may include identification data that indicates when, where, or how to check the computing features (e.g., which values to compare). The identification data may indicate the portion of environment data that corresponds to the policy entry and may indicate a type of computing device (e.g., domain controller, DHCP server), a setting (e.g., registry key), a file location (e.g., file name and offset), an instruction (e.g., command name and parameters), other data, or a combination thereof. The computing device may then analyze the environment data in view of the index data structure to determine the presence of a security vulnerability and compliance with the one or more computing policies.

Systems and methods described herein include technology that enhances the detection and remediation of security vulnerabilities in a computing environment. Traditionally, the burden of detecting and remediating security vulnerabilities is placed on IT administrators, who may not have the time, resources, or appropriate subject matter expertise to analyze every aspect of the computing environment. Aspects of the present disclosure address these deficiencies by enabling a computing device to analyze aspects of a computing environment that may not be readily accessible to an IT administrator and to do so in a manner that scales and can function continuously (e.g., real time monitoring).

Examples of systems, computer-readable storage media and methods according to the disclosed implementations are described throughout this disclosure. The examples are being provided solely to add context and aid in the understanding of the disclosed implementations. It will thus be apparent to one skilled in the art that the disclosed implementations may be practiced without some or all of the specific details provided. In other instances, certain process or method operations, also referred to herein as “blocks,” have not been described in detail in order to avoid unnecessarily obscuring the disclosed implementations. Other implementations and applications also are possible, and as such, the following examples should not be taken as definitive or limiting either in scope or setting.

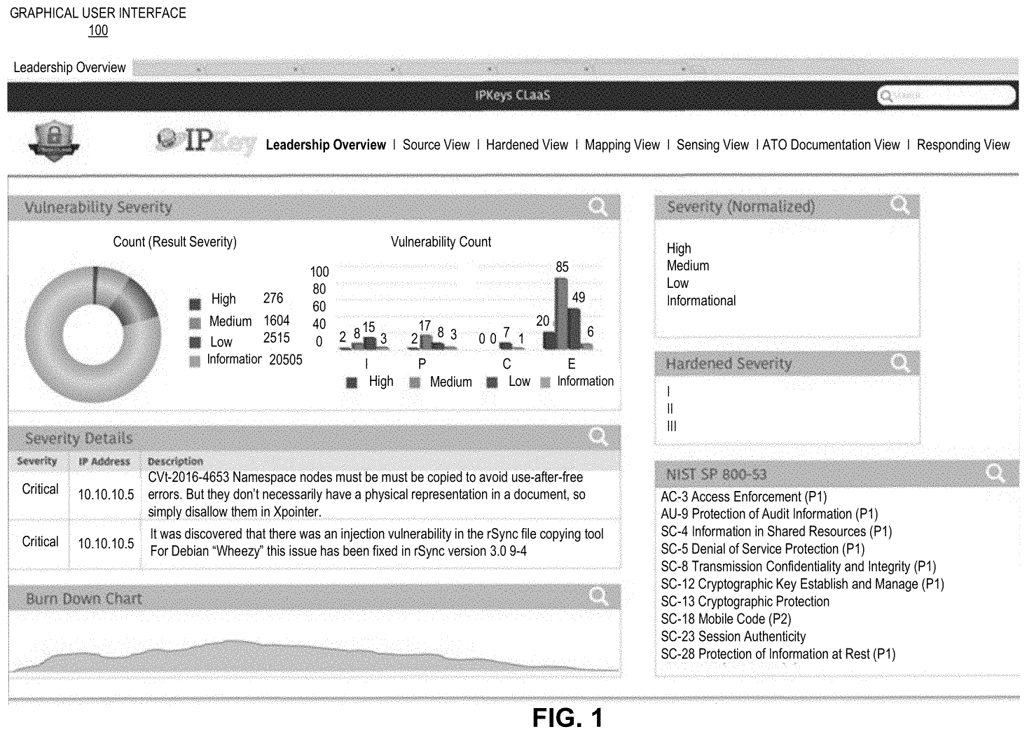

FIG. 1 shows a block diagram of an exemplary computing environment 100, in accordance with some implementations. It should be noted that other arrangements for computing environment 100 are possible, and that the implementation of a computer device utilizing embodiments of the disclosure are not necessarily limited to the specific environment depicted. Computing environment 100 may be specific to a person or to a business organization and may include a distributed computing system and one or more client devices that access the computing devices in the distributed computing system. In the example shown, computing environment 100 may include a distributed computing system 110 (e.g., data center), a computing device 120 (e.g., environment analysis server), a source 130, and a network 140. In some other implementations, computing environment 100 may not have all of these components or systems, or may have other components or systems instead of, or in addition to, those listed above.

Distributed computing system 110 may be any arrangement of computing devices that enables the computing devices to execute one or more computing tasks. Distributed computing system 110 may include computing devices that are spread across one or more geographic locations (e.g., sites). Distributed computing system 110 may be a production system, a pre-production system (e.g., test/development), other system, or a combination thereof. In one example, distributed computing system may include a single data center or multiple geographically-distributed data centers. In another example, distributed computing system 110 may include a portion of a public, private, or hybrid cloud computing infrastructure. In yet another example, distributed computing system 110 may be a single computing device or consolidated onto a single computing device (e.g., host machine). In the example shown in FIG. 1, distributed computing system 110 may include one or more of the computing devices 112A-Z.

Computing devices 112A-Z may include any device capable of processing data and some of the computing devices may be internal to the distributed computing system 110 (e.g., computing devices that are physically located inside the data center) and some of the computing devices may be external to the computing distributed computing system 110 (e.g., computing devices that are physically located outside the data center). Computing devices 112A-Z may include one or more computing devices that function as server devices (e.g., rack servers, workstations), client devices (e.g., personal computers, laptops, tablets, phones, printers, cameras), storage devices (e.g., file servers, database servers, network attached storage (NAS), storage area networks (SAN)), networking devices (e.g., routers, switches, access points), other devices, or a combination thereof. Each of the computing devices 112A-Z may include respective device data 114A-Z. Device data 114A-Z may vary depending on the type of computing device and the same or similar data may be included on multiple different computing devices.

Device data 114A-D may include configuration data, storage data, network data, domain data, log data, other data, or a combination thereof. The configuration data may include operating system data, installed program data, running program data, other data, or a combination thereof. The storage data may include content or metadata (e.g., permissions) of one or more storage items (e.g., file system objects or database records). The network data may include data of a network related device, which may include domain name service (DNS) servers, dynamic host configuration protocol (DHCP) servers, proxy servers, firewalls, gateways, routers, switches, access points, other devices or data, or a combination thereof. The domain data may include data indicating the computing devices, users, and permissions associated with computing environment 100. The log data may include data of historical events and may include system log data, user log data, security log data, other data, or a combination hereof. Device data 114A-Z may be accessible via one or more connections 116.

Connection 116 may provide computing device 120 with access to one or more portions of computing environment 100. As shown in FIG. 1, connection 116 may be a physical connection or a virtual connection with the distributed computing system 110 (e.g., data center). In one example, computing device 120 may be physically located within a data center and may include a physical connection with a computing device of the data center. The physical connection may be a direct wired or wireless connection with a networking device (e.g., Ethernet cord, or Wifi®) or may be a direct wired or wireless connection (e.g., SCSI, USB, bluetooth) with a server device, client device, storage device, other device, or a combination hereof. The virtual connection may be a virtual private network (VPN) connection that makes it appear that the computing device 120 is within the network of the distributed computing system 110. In yet another example, the components of computing device 120 may be installed on a computing device (e.g., server) that is already part of the computing environment 100 and connection 116 may be a prior existing connection within the computing environment 100.

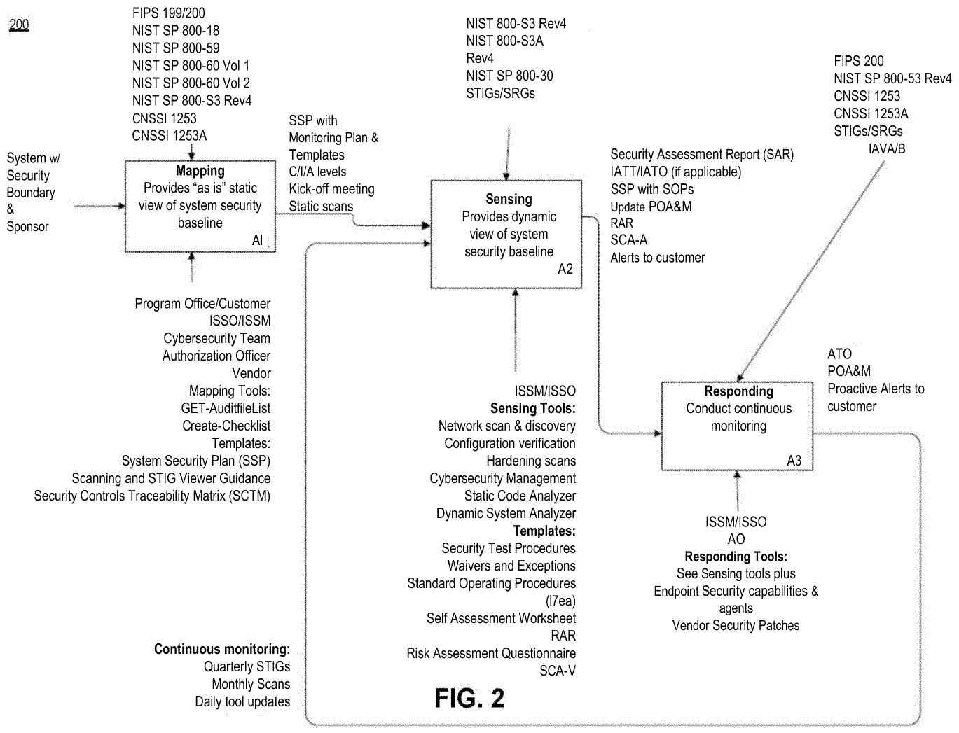

Computing device 120 may function as an environment analysis server and may use connection 116 to access aspects of computing environment 100. Computing device 120 may transmit instructions 123 and receive environment data 125 in response to the instructions. Instructions 123 may be transmitted from one or more programs executing on computing device 120 and may include textual data, binary data, executable data, other data, or a combination thereof. Instructions 123 may include one or more commands, requests, operations, executable code, other instruction, or a combination thereof and may be derived from a script, executable program, other data, or a combination thereof. In the example shown in FIG. 1, computing device 120 may include a policy indexing component 121, an inspection orchestration component 122, an implementation state determination component 124, and a feedback component 126. Components 121, 122, 124, 126 are discussed in more detail in regards to FIG. 2 below and may enable computing device 120 to detect and/or remediate security vulnerabilities to comply with one or more computing policies.

Security vulnerabilities may be weaknesses in one or more aspects of computing environment 100 that enable an attacker (e.g., malicious program or user) to comprise the integrity, availability, or confidentiality of the computing environment. The weaknesses may affect a hardware element, a software element, or a combination thereof. The concept of integrity may refer to the trustworthiness of a resource and exploiting a weakness that compromises the integrity of the computing environment may involve making data modifications discretely and without authorization. The concept of availability may refer to the ability of the attacker to access a resource. For example, an attacker may exploit a weakness of a computing environment to deny a device access to a resource (e.g., ransomware, denial of service attack). The concept of confidentiality may refer to limiting access to information of a resource to particular authorized devices and may be the same or similar to the concept of privacy. If one or more of these concepts are lacking, there may be a security vulnerability even though none may be unexploited. A single security vulnerability may compromise the integrity, availability, confidentiality, other aspect, or a combination thereof. For instance, an information disclosure vulnerability may compromise the confidentiality (e.g., privacy of a user), while a remote code execution vulnerability may compromise the integrity, availability, and confidentiality.

Computing policies 132 may include one or more entries 134A-C that are intended to reduce the quantity or effects of security vulnerabilities. Computing policies 132 may be established by an entity that owns, operates, manages, or hosts distributed computing system 110 or by a separate entity (e.g., third party entity) that is not associated with the distributed computing system 110. The entity may be a government entity, a commercial entity, a non-profit entity, other entity, or a combination thereof and may function as a standards setting body (e.g., National Institute of Standards and Technology (NIST)). The computing polices may be provided in the form of guidelines, standards, specifications, rules, regulations, laws, or a combination thereof. In one example, computing policies 132 may be based on a NIST standard (e.g., NIST SP 800-xx), Sarbanes-Oxley Act (SOX), Health Insurance Portability and Accountability Act (HIPPA), Federal Information Security Management Act (FISMA), other policy, or a combination thereof.

Computing policies 132 may be stored as one or more file objects or database objects and may be in a format that is human readable, machine readable, or a combination thereof. Computing policies 132 may include text in a structured or unstructured format. In one example, a computing policy may include data that is structured using a markup language, such as Extensible Markup Language (XML), Hypertext Markup Language (HTML), other language, or a combination thereof. In another example, the computing policy may include data in an image format (e.g, Tagged Image File Format (TIFF), Portable Document Format (PDF)), a text format (e.g., text file (TXT), word processing document (DOC, OTF)), spreadsheet format (comma separated value (CSV), excel (XLS)), other format, or a combination thereof. In either example, computing policies 132 may be available in a physical form, an electronic form, other form, or a combination thereof and may be provided by one or more sources 130.

Source 130 may store computing policies 132 and transmit computing policies 132 to one or more requesting entities. Source 130 may be a source that transmits computing policies via electronic transmission (e.g., download, stream, email) or via physical transmission (mailing a printout or electronic storage medium). Source 130 may be associated with the entity that promulgates the computing policy or may be separate from the entity that promulgates the computing policy.

Network 140 may include any network or combination of networks of systems or devices that communicate with one another. For example, the network 140 can be or include any one or any combination of a LAN (local area network), WAN (wide area network), telephone network, wireless network, cellular network, point-to-point network, star network, hub network, or other appropriate configuration. The network 140 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

FIG. 2 depicts a block diagram illustrating an exemplary computing device 120 that functions as a computing environment analysis server, in accordance with aspects of the disclosure. Computing device 120 may be the same or similar to computing device 120 of FIG. 1 and include a policy indexing component 121, an inspection orchestration component 122, an implementation state determination component 124, and a feedback component 126. More or less components or modules may be included without loss of generality. For example, two or more of the components may be combined into a single component, or features of a component may be divided into two or more components. In one example, computing device may support virtualization technology (e.g., hardware virtualization) that enables computing device 120 to execute multiple operating systems concurrently (e.g., guest operating systems on virtual machines) and one or more of features of a component 121, 122, 124, 126 may be executed by different guest operating systems (e.g., one feature by Linux® VM and another feature by a Windows® VM). In other examples, the one or more features of a component 121, 122, 124, 126 or separate components may be executed on different computing devices (e.g., a server device and a client device).

Computing device 120 may use components 121, 122, 124, and 126 to perform one or more of the features such as: discovery of network topology, assets, and communications (e.g., ports, protocols, and services); capability to perform security testing of web applications; interactive analysis capability for cybersecurity data/artifacts; automatic techniques customizable for testing needs; includes proxy server, a web spider, scanner, intruder, repeater, sequencer, decoder, collaborator, extender, and other related features; performs vulnerability assessment and management; Dynamic Application Security Testing (DAST), which identifies vulnerabilities by examining applications in or from our CLaaS environment; Static Application Security Testing (SAST), which allows analysis of source code before it goes into production; identifies vulnerabilities, cybersecurity policy violating configurations and malware that attackers could use to penetrate the network or endpoint assets; visualization of data, reports, and files to virtualize data in a context for decision makers and stakeholders (e.g., authorization officers, system administrators, and developers); cybersecurity methodology for hardening networks, servers, and endpoints. Policy indexing component 121 may enable computing device 120 to analyze a computing policy and create an index data structure that associates the entries of the computing policy to corresponding computing features of a computing environment. As discussed above, the entries may be policy requirements that indicate terms that a distributed computing system can satisfy to comply with the computing policy. In one example, a computing policy may include an entry that specifies that passcodes/keys have a minimum complexity (e.g., character or bit length). Correspondingly, the index data structure may include data for identifying the entry and indicating that the entry corresponds to particular computing features of a computing environment (e.g., domain account password, root password, BIOS password). In another example, a computing policy may include entries that dictate what, where, when, or how data is handled, which may involve storing data, accessing data, deleting data, modifying data, sharing data, or other operation on data, or a combination thereof. In the example shown in FIG. 2, policy indexing component 121 may include a policy accessing module 213, an entry detection module 215, a feature determination module 217, and an index creation module 219.

Policy accessing module 213 may access computing policies from one or more sources (e.g., source 130) and store data of the computing policies as security vulnerability data 225. In one example, policy accessing module 213 may transmit a request for the computing policy to the source and the source may provide access to the computing policy. Providing access may involve initiating the transmission of the computing policy to computing device 120 or providing a location (e.g., URL) and/or credentials to use to access the computing policy from another location. Policy accessing module 213 may then download, stream, or access data of one or more computing policies. In one example, the computing policies may be different versions (e.g., revisions, editions) of the same computing policy and received from the same or different sources. In another example, the computing policies may be different computing policies received from different sources. Each of the computing policies may apply to the same or different aspects of the computing environment. The different sources may be sources associated with the respective entity establishing the computing policy (e.g., standards body) or may be associated with an entity that aggregates or shares computing policies and is different from the entity establishing the computing policies. As discussed above, the source may provide a computing policy in an electronic form (e.g., XML file, PDF document), a physical form (e.g., print out), other form, or a combination thereof and may be analyzed by entry detection module 215.

Entry detection module 215 may process a computing policy to detect one or more entries within the computing policy. Processing the computing policy may include operations that involve parsing, extracting, searching, filtering, redacting, image scanning, digital image processing (e.g., Optical Character Recognition (OCR)), other operations, or a combination thereof to detect an entry. The entry may correspond to a portion of the computing policy that indicates a condition that one or more computing devices of the computing environment may or may not comply with. An entry may or may not identify a particular issue, computing feature, or solution (e.g., implementation) and may include a binary condition, a threshold condition, or a combination thereof. A binary condition may require or prohibit the existence or implementation of a computing feature. A threshold condition may provide a threshold value that a computing feature needs to satisfy to comply with the computing policy. The computing feature may be satisfied when a configuration value associated with the computing features is above a threshold value, below a threshold value, between threshold values, or other variation. As discussed herein, entries of the computing policy may be the same or similar to requirements, constraints, restrictions, limitations, prerequisites, obligations, recommendations, demands, responsibilities, duties, expectations, suggestion, other term, or a combination thereof. In one example, the computing policy may be represented by an Extensible Markup Language (XML) file and the entry may be extracted from the XML file and include one or more predetermined threshold configuration values (e.g., upper or lower limit).

Feature determination module 217 may determine computing features that correspond to the entries detected by entry detection module 215. A single entry of a computing policy may correspond to one or more computing features of a computing environment. A computing feature may relate to a configuration of one or more computing devices, services, or other aspects of a computing environment. The computing feature may relate to hardware or software in the computing environment and may correspond to any features represented by device data 114A-D, environment data 125, other data, or a combination thereof.

Feature determination module 217 may execute before, during, or after a target computing environment has been selected. In one example, feature determination module 217 may analyze an entry based on a specific target computing environment (e.g., production or test environment). In another example, feature determination module 217 may analyze entries of a computing policy to identify computing features that exist in a model computing environment. The model computing environment may be a simulated computing environment that may be based on a hypothetical computing environment or one or more or more actual computing environments that existed in the past (e.g., historical environment), present (e.g., current environment), or future (e.g., planned environment). In either example, feature determination module 217 may use user input, artificial intelligence (e.g. machine learning, deep learning, neural networks), other input or analysis or feedback mechanism, or a combination thereof to determine computing features that relate to a particular entry.

Index creation module 219 may generate an index data structure 228 that represents associations between policy entries and computing features. Index data structure 228 may be any data structure that is capable of associating a policy entry with one or more computing features or a computing feature with one or more policy entries. The association may indicate a relationship or correlation and may be represented by links (e.g., pointers). A single policy entry may link to multiple computing features and a single computing feature may link to multiple policy entries. Each link may include identification data of a particular entry (e.g., entry identifier) and/or identification data of a particular computing feature (e.g., process name, settings file, configuration value). The association may be unidirectional, a bidirectional, multi directional, or a combination thereof and may be represent relationships that are one-to-one, one-to-many, or many-to-one, many-to-many. In one example, index data structure may include an element for each policy entry, an element for each computing feature, an element for each relationship, other arrangement of elements, or a combination thereof. Index data structure 228 may be inspected (e.g., queried) by computing device 120 to resolve a policy entry to the corresponding computing feature or a computing feature to the corresponding policy entries, or a combination thereof.

When another version of the computing policy is available, the index creation module 219 may process the other version of the computing policy and update the index data structure. Each version of the computing policy may be established by the same entity (e.g., standards organization) and may include one or more modifications (e.g., revisions, additions, deletions). Each version of a computing policy may be considered a “different computing policy” but may all relate to a base version of the computing policy and may be referred to as subsequent versions (e.g., newer versions), prior versions (e.g., older versions), or other version. Updating the index data structure in view of the different versions of the computing policy may be performed in different manners. In one example, the index creation module 219 may update index data structure 228 and replace the current version of the index data structure 228. In another example, index creation module 219 may create a new version of index data structure 228 for each version of the computing policy without replacing the other version.

The multiple versions of index data structure 228 may be available to computing device 120 and be accessed or used simultaneously to assess a computing environment. The different versions of the index data structure may be stored as full versions of the index data structure that may or may not be linked to one another. The different versions may also or alternatively be stored as one or more delta versions of the index data structure. A delta version may indicate changes compared to a base version and the base version may be a more recent version of the index data structure (e.g., a current version) or a past version of the index data structure (e.g., an initial version).

When multiple different computing policies are available, the index creation module 219 may process the computing polices and create an index data structure that represents the multiple different computing policies. The computing policies may be different because they are established by different entities and may be available from different sources or from the same source. An index data structure 228 that corresponds to multiple different computing policies may be referred to as a composite index data structure but may also or alternatively be referred to as an aggregate index data structure, a combined index data structure, a joint index data structure, or other term. The composite index data structure may be associated (e.g., linked) with a plurality embedded index structures that each represent one of the multiple different computing policies. The composite index data structure may also be versioned as discussed above to create a versioned composite index data structure.

The use of composite index data structures and/or the versioned index data structures may be particularly useful when different computing environments or different portions of a single computing environment are assessed using different computing policies. The different computing policies may be computing policies established by different entities or different versions of the same base computing policy and established by the same entity or entities. Different computing policies may apply when a computing environment or portion of a computing environment is associated with different industries (e.g., finance, government, telecommunication, social media, advertising), data classification levels (e.g., top secret, confidential, informational), entity size (startup company, large corporation), publicity status (e.g., private vs publicly traded), time periods (e.g., new version after particular date), other aspect, or a combination thereof.

As discussed above, policy indexing component 121 may be used to index one or more computing policies and may be performed by computing device 120 or by another device. In one example, policy indexing component 121 may be executed by a first computing device 120 and data of the policy indexing component 121 (e.g., index data structure 228) may be accessed by an inspection orchestration component 122 executing on a second device. In another example, policy indexing component 121 and inspection orchestration component 122 may execute on the same device. In either example, the index data structure 228 may be created before, during, or after inspection orchestration component 122 executes.

Inspection orchestration component 122 may extract and/or derive environment data 125 from a target computing environment. Environment data 125 may indicate a configuration of the target computing environment and may include a plurality of configuration values that represent or indicate different computing features of the target computing environment. Environment data 125 may be determined using instructions 123 and may be based on the device data of one or more computing devices of the computing environment. Environment data 125 may be in the same form as the device data discussed above or may be in a different form and may be reformatted, encoded, decoded, compressed, filtered, aggregated, other data transformation, or a combination thereof. In one example, inspection orchestration component 122 may include a discovery module 212, an environment modeling module 214, a device inspection module 216, and a code inspection module 218.

Discovery module 212 may enable computing device 120 to discover different aspects of the computing environment. Discovery module 212 may discover computing devices by scanning, broadcasting, requesting, probing, other technique, or a combination thereof. Discovery module 212 may interact with one or more management servers of the computing environment. The management servers may include DHCP servers, DNS servers, domain servers (e.g., domain controllers), provisioning servers, development servers, deployment servers, other aspect of a computing device, or a combination thereof. A management server may provide data that indicates the computing devices that exist within the computing environment (e.g., servers, clients, network devices, code repositories). Discovery module 212 may then access one or more of these computing devices to identify additional computing devices. For example, discovery module 212 may access a domain controller to identify which computing devices and users are associated with the computing environment. Discovery module 212 may also or alternatively access the DHCP server to identify which IP addresses have been dynamically assigned (e.g., assigned to client devices) or which IP addresses have been reserved (e.g., statically assigned to server devices).

Discovery module 212 may perform one or more discovery processes with or without user input. In one example, discovery module 212 may automatically perform the discovery in the absence of user input. For example, the discovery may occur automatically once computing device 120 is connected to the computing environment. In another example, computing device 120 may retrieve user input before, during, or after being connected to the computing environment. The user input may be provided by an IT administrator of the computing environment and may indicate one or more proprietary settings (e.g., administrator credentials, domain names, server IP addresses, repository locations). The user input may be retrieved from a configuration file that is accessible to the computing device or may be retrieved via a user interface (e.g., graphical user interface (GUI), command line interface (CLI)), other interface, or a combination thereof.

Environment modeling module 214 may access data of discovery module 212 and build one or more models of the computing environment. A model may be a data structure that includes one or more graphs with one or more nodes and edges. Each node may represent a computing device or a process executing on the computing device and the edges may represent interactions or communication channels between different computing devices or different processes executing on one or more computing devices. In one example, the model may represent the network topology, computer program interactions, other interactions, or a combination hereof. The model may also indicate the type of computing device (e.g., server device, client device, storage device, networking device) and the services performed (e.g., roles, functions, tasks). The services may include, but are not limited to, web services, file services, database services, print services, program update services, code repository services, build services, domain services, DHCP services, DNS services, other services, or a combination thereof.

Device inspection module 216 may access the data discussed above and inspect one or more of the computing devices. Device inspection module 216 may interact with a computing device and gather device data about the hardware of the computing device and/or the software of the computing device. The hardware data may correspond to one or more hardware features such as, but not limited to, hardware identification information, computing resource details (e.g., processing power, storage space, data time information), processor architecture (e.g., version, designer, manufacturer), or a combination thereof. The software features may include information about the firmware, kernel, operating system, installed programs, running programs, versions, duration, times, open ports, user accounts, account access, domain registration, file handles, network sockets, other software related information, or a combination thereof. In one example, device inspection module 216 may enable computing device 120 transmit instructions to a plurality of computing devices of the computing environment and receive device data of the plurality of computing devices. Computing device 120 may then use the device data to derive environment data 125 or refine environment data 125 (e.g., supplement, enrich, filter, or redact).

Code inspection module 218 may access the data discussed above and inspect computer code of the computing devices. The computer code may include any code associated with one or more computer programs and the code may be source code, executable code, other code, or a combination thereof. Source code may include human readable computer code that is in a textual form. The source code may be subsequently compiled, linked, interpreted, other action, or a combination thereof prior to being executed by a computing device. Executable code may include machine-readable code that can be directly executed by a processor of a computing device or indirectly executed by a processor of a computing device (e.g., intermediate code, byte code). Code inspection module 218 may inspect and analyze the computer code using static analysis, run time analysis, other analysis, or a combination thereof.

Inspection orchestration component 122 may perform a generic inspection that is not particular to any one computing policy or may perform a targeted inspection that is based on a particular computing policy (e.g., index data structure 228). When performing a generic inspection, inspection orchestration component 122 may inspect a larger portion of a computing environment and gather more environment data. This may enable the resulting environment data to be assessed in view of one or more computing policies and the computing policy may be selected before, during, or after the inspection is performed. When performing a targeted inspection, inspection orchestration component 122 may use index data structure 228 to target the inspection to particular portions of the computing environment that correspond to index data structure (e.g., selected computing policy) and may avoid inspecting other portions of the computing environment (e.g., those unrelated to the computing policy). This may reduce the consumption of processing resources (e.g., processor cycles, power consumption), data storage resources (e.g., hard disk, memory), input/output (I/O) resources (e.g., network connection) consumed by inspection orchestration component 122 and by implementation state determination component 124.

Implementation state determination component 124 may analyze the data discussed above and determine a security state of the computing environment in view of one or more computing policies. The security state may be represented by one or more profiles that enumerate one or more of the security vulnerabilities and indicate portions of the computing environment that are or are not in compliance with a computing policy. In one example, implementation state determination component 124 may include an index selection module 221, a correlation module 222, a vulnerability detection module 224, and a profile generation module 226.

Index selection module 221 may enable computing device 120 to select one or more index data structures 228 for assessing the computing environment. The selection may be based on user input data, environment data 125, device data 114A-Z, other data, or a combination thereof. The user input data that may be provided by a user via one or more graphical user interfaces (e.g., dialog box, wizard, installer), command line interfaces (e.g., CLI prompt), predefined settings (e.g., entry in a configuration file, registry, script, batch file), other input, or a combination thereof. In one example, index selection module 221 may analyze the above data to identify and present one or more applicable computing policies to a user. Index selection module 221 may then receive a user selection and select one or more index data structures that correspond to the user selection. The selected index data structures may then be accessed by correlation module 222.

Correlation module 222 may use index data structure 228 to correlate policy entries with the data discussed above (e.g., environment data). Correlation module 222 may analyze the index data structure 228 to determine which computing features relate to a policy entry and may identify one or more configuration values (e.g., ranges of values) that correspond to compliance, incompliance, or a combination thereof. Correlation module 222 may supplement the data discussed above with data derived from an external source. The external source may provide data corresponding to computing policies or known vulnerabilities or flaws with particular computer programs (e.g., kernel version and patch level), configurations, computing devices, hardware components, other aspects of a computing environment, or a combination thereof. Correlation module 222 may analyze extracted data and external data and compare, organize, filter, resolve, link, other operation, or a combination thereof to transform the data.

Vulnerability detection module 224 may access any of the data discussed herein to detect whether a vulnerability exists in the computing environment and how it affects a computing policy. In one example, the vulnerability detection module 224 may be the same or similar to a compliance detection module and may determine whether a security vulnerability exists based on the environment data and the index data structure. The results of vulnerability detection module 224 may be stored as security vulnerability data 225 in data store 220.

Some example vulnerabilities and potential feedback provided by computing device 120 may include: vulnerabilities discovered in the Linux kernel that may lead to a privilege escalation, denial of service, or information leaks; detecting an ability of an attacker to inject executed code via user input (e.g., POST), which is retrieved by the web site in the do bracket magic method; system failed compliance checks for SOX (3 issues), HIPAA (42 issues), FISMA (8 issues); Windows Operating System Installer “always install with elevated privileges” must be disabled; rogue access point was detected on network; credentialed Patch Audit found 2000+ hosts w/3000+ vulnerabilities found; bad lock detection: Ricoh printer has critical vulnerability service enabled; network device must not use the default or well-known SNMP community strings public and private; system must not have accounts configured with blank or null passwords; operating system must not allow an unattended or automatic logon to the system via a graphical user interface; gateway firewall must continuously monitor outbound communications traffic for unusual/unauthorized activities or conditions; outbound communications traffic to unauthorized destinations were detected; remediation cost estimates for high and medium risk vulnerabilities is approx. $7 k and requires application developer and database administrator to fix. Other vulnerabilities and potential feedback may be provided in addition or as an alternative.

Profile generation module 226 may generate a profile that represents the security vulnerabilities that are present in the computing environment and how they affect one or more compliance policies. Profile generation module 226 may generate multiple profiles and one or more of the profiles may function as a baseline that approximates the state of the computing environment at a particular point in time. Profile generation module 226 may include or generate baselines or profiles (e.g., profile data 227) based on a computing compliance. The baselines of the computing environment may be compared to a baseline of the standards organization (e.g., required, recommended, suggested, or informational baseline) to indicate a compliance or non-compliance with the computing policy. The baselines of the computing environment may also or alternatively be compared to one or more prior or subsequent baselines of the same computing environment to determine changes (e.g., enhancements or regressions) over time in the security or compliance of the computing environment.

Feedback component 126 may enable computing device 120 to provide feedback to the computing environment or to one or more user devices (e.g., Administrator console device). The feedback may indicate the content of the security state (e.g., profile), extracted data, solutions, other data or a combination hereof. The feedback may relate to one or more computing policies and may include one or more visualizations, artifacts, remediation tasks, or a combination thereof. In one example, feedback component 126 may include a visualization module 232, an artifact creation module 234, and a remediation module 236.

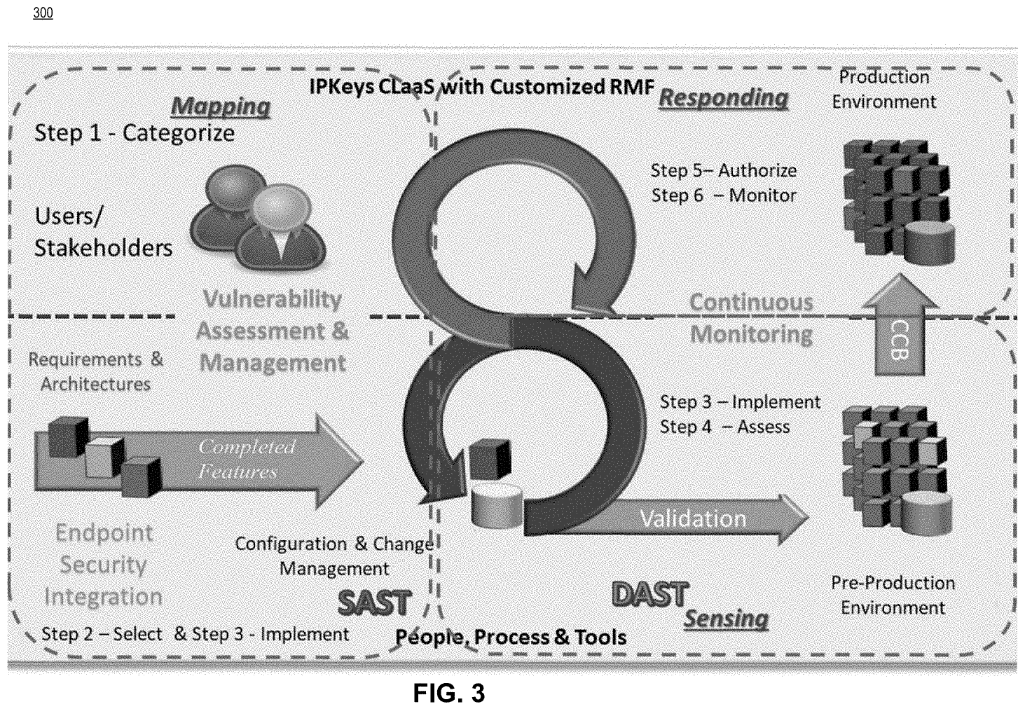

Visualization module 232 may provide a graphical user interface (GUI) that presents the feedback to one or more users. The users may include IT administrators, developers, organizational executives (e.g., CTO, CEO), inspectors, consultants, other users, or a combination thereof. The visualization may indicate one or more violations of the computing policy and may include data identifying one or more computing devices (e.g., device names) and one or more policy requirements of the computing policy (e.g., policy numbers). An example of a possible user interface is provided by FIG. 3 and may display information about one or more artifacts generated by artifact creation module 234.

Artifact creation module 234 may create artifacts that represent the state (e.g., profile) of the computing environment. In one example, the artifacts may be a document with text, tables, checklists, charts, images, movies, or a combination thereof. The artifacts may indicate the existence or non-existence of one or more security vulnerabilities, compliance comparisons, solutions, other data, or a combination thereof.

Remediation module 236 may provide feedback that enables the computing environment to be updated to address a security vulnerability. The feedback may include instructions, costs, time durations, other data, or a combination thereof. In some examples of computing system, there may also be verification features that check to ensure that a known security vulnerability has been addressed. This may involve a subsequent scan or continuous monitoring.

FIG. 3 depicts an exemplary graphical user interface 300 provided by visualization module 232 and may display results of an analysis of one or more computing environments. Graphical user interface 300 may include one or more windows, panels, regions, areas, or portions that are used to visualize data, devices, services, tasks, or actions discussed above. Graphical user interface 300 may include text, tables, checklists, charts, graphs, images, or a combination thereof. Graphical user interface 300 may include one or more tabs, for example, there may be multiple tabs that are respectively entitled “Leadership Overview,” “Source Code View,” “Hardened View,” “Mapping View,” “Sensing View,” “Documentation View,” and “Responding View.” Graphical user interface 300 may also include a region that categorizes the security vulnerabilities. For example, the categories may include “High,” “Medium,” “Low,” and “Informational.” Graphical user interface 300 may include a region entitled “Vulnerability Severity” that may include one or more images (e.g., bar graph and a donut chart) that represent the count of vulnerabilities in each of the four categories. Graphical user interface 300 may include a region entitled “Severity Details” that lists one or more vulnerabilities and the corresponding description of the vulnerability and the IP address of the computing device involved with the vulnerability. Graphical user interface 300 may include a burn down chart that may visually represent the work done to enhance the security over time. The burn down chart may show historical data and/or future data (e.g., extrapolated data).

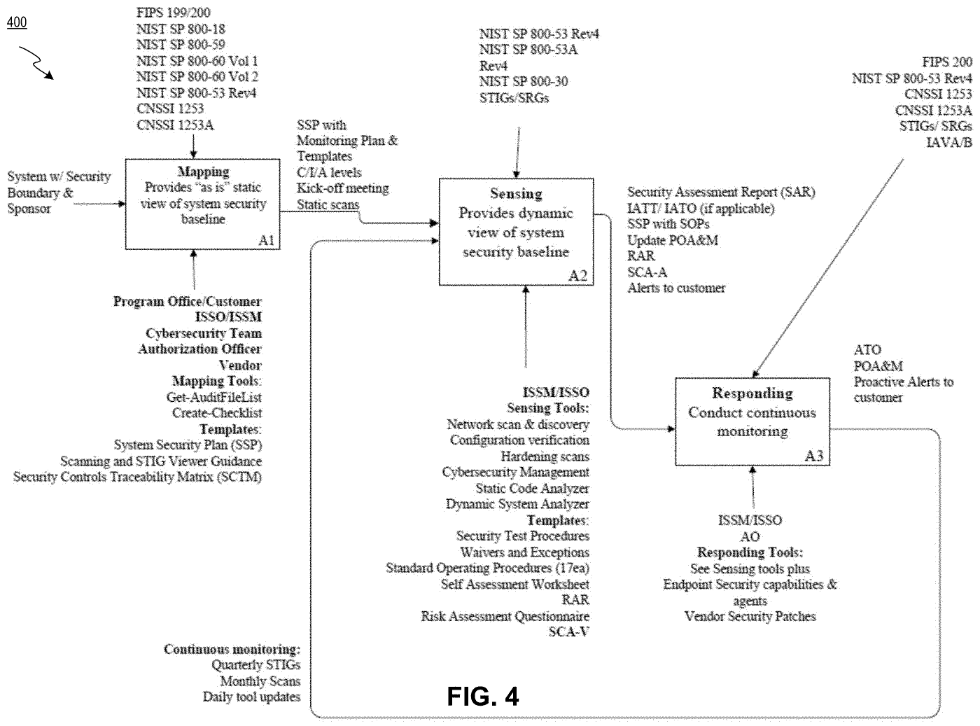

FIG. 4 depicts a flow diagram illustrating an exemplary process 400 for analyzing and updating a computing environment and may be performed by one or more computing device in accordance with aspects of the disclosure. The flow diagram includes blocks A1 through A3 but more or less blocks may be implemented. Block A1 discusses a mapping phase, which may involve executing features of the policy indexing component 121 and may provide a static view of computing policies and a system security state (e.g., target baseline) representing a compliance goal of the computing environment. Block A2 may include a sensing phase that involves executing features of the inspection orchestration component 122 and implementation state determination component 124 to provide a dynamic view of a current system security state (e.g., current baseline). Block A3 may include a responding phase that involves executing features of feedback component 126 while conducting continuous monitoring of the computing environment.

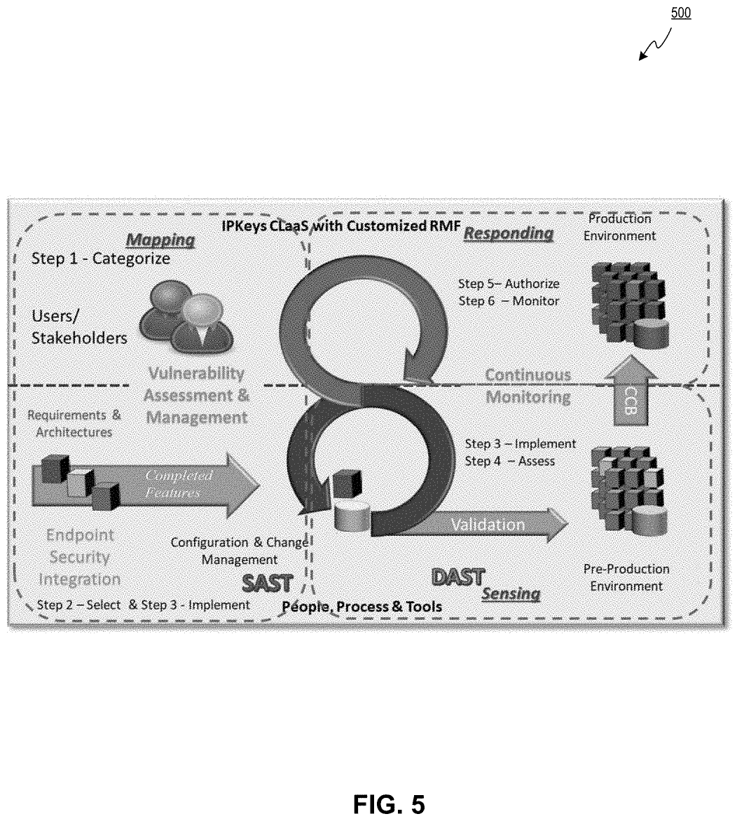

FIG. 5 depicts a flow diagram illustrating an exemplary process 500 for analyzing and updating a computing environment and may be performed by one or more computing devices in accordance with aspects of the disclosure. The flow diagram includes steps 1 through 6 but more or less steps may be implemented. Step 1 may include categorizing, which may involve receiving input from one or more stakeholders (e.g., user input) and executing policy indexing component 121. Step 2 may involve identifying computing features of the computing environment to analyze and may be performed by inspection orchestration component 122. Step 3 and step 4 may involve implementing an assessment of the computing features of the computing environment and may involve executing implementation state determination component 124. Step 5 may involve authorizing modifications to be deployed in a production environment and may involve executing feedback component 126. Step 6 may involve monitoring the production version of the computing environment to ensure security vulnerabilities are not worsened and verifying existing vulnerabilities are addressed when appropriate.

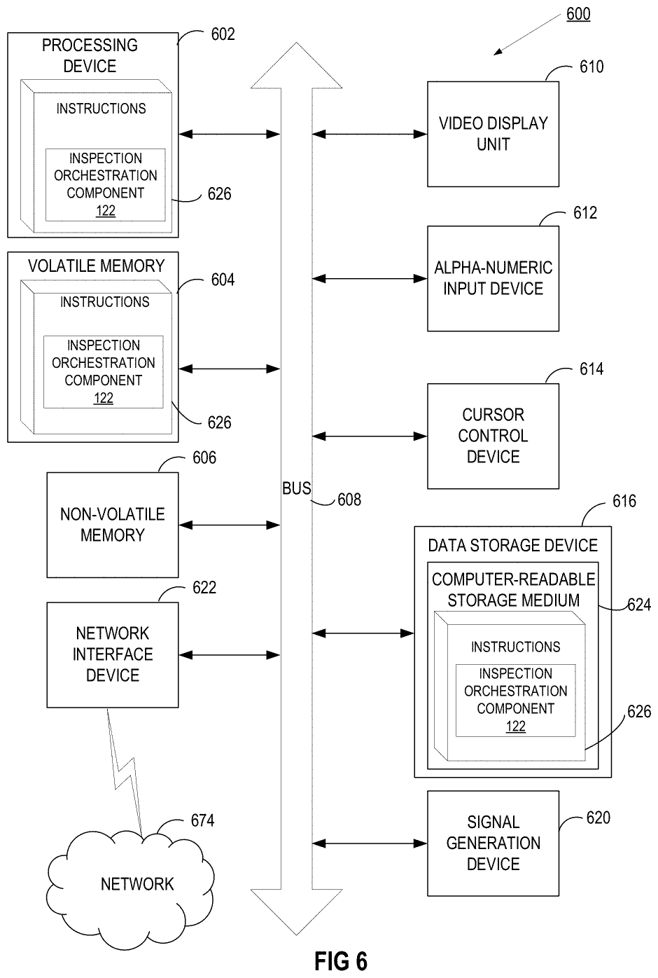

FIG. 6 depicts a block diagram of a computer system operating in accordance with one or more aspects of the present disclosure. In various illustrative examples, computer system 600 may correspond to computing device 120 of FIGS. 1 and 2.

The computer system may be included within a data center or external to a data center. In certain implementations, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., random access memory (RAM)), a non-volatile memory 606 (e.g., read-only memory (ROM) or electrically-erasable programmable ROM (EEPROM)), and a data storage device 616, which may communicate with each other via a bus 608.

Processing device 602 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 600 may further include a network interface device 622. Computer system 600 also may include a video display unit 610 (e.g., an LCD), an alphanumeric input device 612 (e.g., a keyboard), a cursor control device 614 (e.g., a mouse), and a signal generation device 620.

Data storage device 616 may include a non-transitory computer-readable storage medium 624 on which may store instructions 626 encoding any one or more of the methods or functions described herein, including instructions for implementing processes 400, 500, or 700 and for encoding multiple components of FIGS. 1 and 2 (e.g., inspection orchestration component 122).

Instructions 626 may also reside, completely or partially, within volatile memory 604 and/or within processing device 602 during execution thereof by computer system 600, hence, volatile memory 604, and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs, or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “initiating,” “transmitting,” “receiving,” “determining,” “analyzing,” “providing,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. In addition, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general-purpose computer system selectively programmed by a computer program stored in the computer system. Such a computer program may be stored in a computer-readable tangible storage medium.

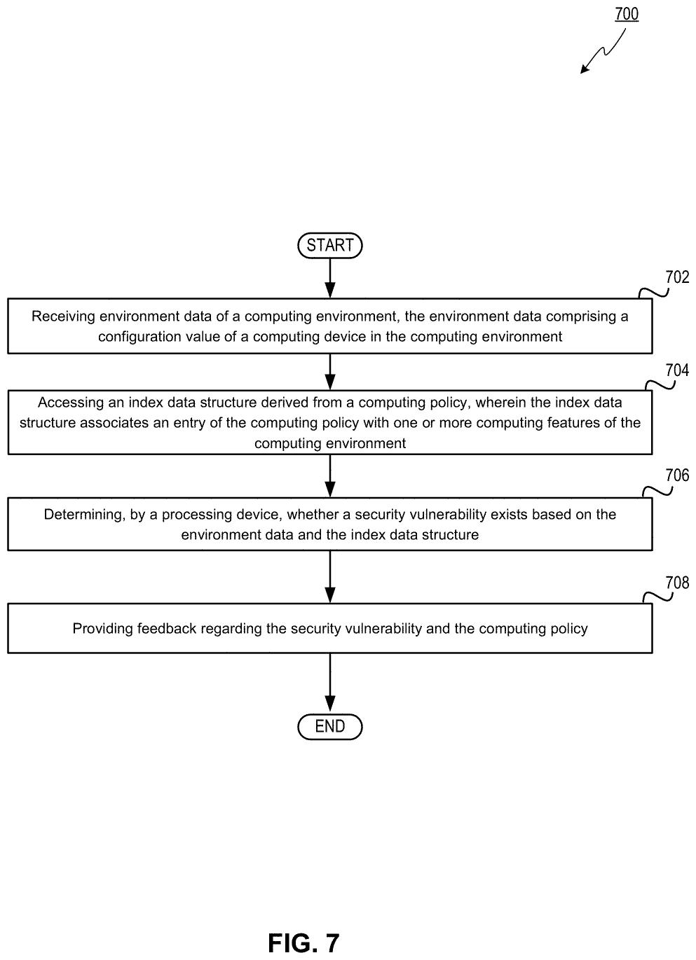

FIG. 7 depicts a flow diagram of one illustrative example of a method 700 in accordance with one or more aspects of the present disclosure. Method 700 and each of its individual functions, routines, subroutines, or operations may be performed by one or more processors of the computer device executing the method. In certain implementations, method 700 may be performed by a single computing device. Alternatively, methods 700 may be performed by two or more computing devices, each computing device executing one or more individual functions, routines, subroutines, or operations of the method.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 700 may be performed by one or more components 122, 124, and 126 as shown in FIGS. 1 and 2.

Method 700 may be performed by processing devices of a server device or a client device and may begin at block 702. At block 702, a processing device (e.g., processor) may receive environment data of a computing environment and the environment data may include a configuration value of a computing device in the computing environment. In one example, the processing device may transmit instructions to a plurality of computing devices of the computing environment and receive device data of the plurality of computing devices. The processing device may derive the environment data in view of the device data and the environment data may indicate a configuration of the computing environment.

At block 704, the processing device may access an index data structure derived from a computing policy. The index data structure may associate an entry of the computing policy with one or more computing features of the computing environment. The computing policy may be accessed in the form of an Extensible Markup Language (XML) file and the entry may be extracted from the XML file and include one or more predetermined threshold configuration values. The processing device may access a plurality of computing policies from one or more sources and detect entries (e.g., requirements, constraints) of the computing policies. The processing device may determine computing features for each of the plurality of entries and generate index data structures for each computing policy. At least one of the index data structures may associate (e.g., uni-directionally or bi-directionally link) a single entry with multiple computing features. In one example, the plurality of computing policies are different computing policies received from different sources and the index data structure may be a composite index data structure associated with (e.g., including) a plurality of index data structures. In another example, the plurality of computing policies may be different versions (e.g., revisions, editions, updates) of the same computing policy and may be received from a single source. Each of the different versions of the computing policy may correspond to a respective version of the index data structure. In either example, the different versions of the index data structures may be concurrently accessible to the processing device.

At block 706, the processing device may determine whether a security vulnerability exists based on the environment data and the index data structure. The determination may involve analyzing the index data structure to identify policy elements and the computing features that correspond to the policy element. The processing device may then access the portion of the environment data that corresponds to each computing feature and compare one or more configuration values of the environment data with one or more configuration values of the policy element. If the environment data does not satisfy a particular entry of the computing policy the processing device may indicate that the particular entry is not satisfied (e.g., security vulnerability).

At block 708, the processing device may provide feedback regarding the security vulnerability and the computing policy. The feedback may include a visualization, a remediation task, or an artifact. The visualization may indicate one or more violations of the computing policy and comprises data indicating one or more computing devices and one or more entries of the computing policy. Responsive to completing the operations described herein above with references to block 710, the method may terminate.

The methods and illustrative examples described herein are not inherently related to any particular computer or other apparatus. Various general-purpose systems may be used in accordance with the teachings described herein, or it may prove convenient to construct more specialized apparatus to perform processes 400, 500, 700, and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

References are made to the accompanying drawings, which form a part of the description and in which are shown, by way of illustration, one or more specific implementations. Although these disclosed implementations are described in sufficient detail to enable one skilled in the art to practice the implementations, it is to be understood that these examples are not limiting, such that other implementations may be used and changes may be made to the disclosed implementations without departing from their spirit and scope. For example, the blocks of the methods shown and described herein are not necessarily performed in the order indicated in some other implementations. Additionally, in some other implementations, the disclosed methods may include more or fewer blocks than are described. As another example, some blocks described herein as separate blocks may be combined in some other implementations. Conversely, what may be described herein as a single block may be implemented in multiple blocks in some other implementations. Additionally, the conjunction “or” is intended herein in the inclusive sense where appropriate unless otherwise indicated; that is, the phrase “A, B or C” is intended to include the possibilities of “A,” “B,” “C,” “A and B,” “B and C,” “A and C” and “A, B and C.”

What is claimed is:

1. A method comprising:
receiving environment data of a computing environment, the environment data comprising a configuration value of a computing device in the computing environment;
accessing an index data structure derived from a computing policy, wherein the index data structure associates an entry of the computing policy with one or more computing features of the computing environment;
determining, by a processing device, whether a security vulnerability exists based on the environment data and the index data structure; and
providing feedback regarding the security vulnerability and the computing policy.

2. The method of claim 1, further comprising
transmitting, by the processing device, instructions to a plurality of computing devices of the computing environment;
receiving device data of the plurality of computing devices in response to the instructions; and
deriving the environment data in view of the device data, wherein the environment data indicates a configuration of the computing environment.

3. The method of claim 1, wherein the computing policy comprises an Extensible Markup Language (XML) file, and wherein the entry is extracted from the XML file and comprises one or more predetermined threshold configuration values.

4. The method of claim 1, further comprising:
accessing a plurality of computing policies from one or more sources, wherein the plurality of computing policies comprises the computing policy;
detecting a plurality of entries of the computing policy;
determining multiple computing features that correspond to a single entry of the plurality of entries; and
generating index data structures for the computing policies, wherein one of the index data structures associates the single entry with the multiple computing features.

5. The method of claim 4, wherein the plurality of computing policies are different versions of the computing policy and are received from a single source, and wherein there are multiple corresponding versions of the index data structure.

6. The method of claim 4, wherein the plurality of computing policies are different computing policies received from different sources, and wherein the index data structure is a composite index data structure associated with a plurality of index data structures.

7. The method of claim 1, wherein the computing policy includes an update to a prior version of the computing policy and wherein generating the index data structure comprises updating a prior version of the index data structure.

8. The method of claim 7, wherein the index data structure and the prior version of the index data structure are concurrently accessible to the processing device.

9. The method of claim 1, wherein the feedback comprises at least one of a remediation task, a visualization, or an artifact.

10. The method of claim 9, wherein the visualization indicates one or more violations of the computing policy and comprises data indicating one or more computing devices and one or more entries of the computing policy.

11. The method of claim 1, further comprising selecting a version of the index from a plurality of versions of the index based on user input.

12. A system comprising:
a memory; and
a processing device communicably coupled to the memory, the processing device to:
receive environment data of a computing environment, the environment data comprising a configuration value of a computing device in the computing environment;
access an index data structure derived from a computing policy, wherein the index data structure associates an entry of the computing policy with one or more computing features of the computing environment;
determine whether a security vulnerability exists based on the environment data and the index data structure; and
provide feedback regarding the security vulnerability and the computing policy.

13. The system of claim 12, wherein the computing policy comprises an Extensible Markup Language (XML) file, and wherein the entry is extracted from the XML file and comprises one or more predetermined threshold configuration values.

14. The system of claim 12, wherein the index data structure and a prior version of the index data structure are concurrently accessible to the processing device.

15. The system of claim 12, wherein the feedback comprises a remediation task, a visualization, or an artifact.

16. The system of claim 12, wherein the visualization indicates one or more violations of the computing policy and comprises data indicating one or more computing devices and one or more entries of the computing policy.

17. A non-transitory machine-readable storage medium comprising instructions that cause a processing device to:
receive environment data of a computing environment, the environment data comprising a configuration value of a computing device in the computing environment;
access an index data structure derived from a computing policy, wherein the index data structure associates an entry of the computing policy with one or more computing features of the computing environment;
determine whether a security vulnerability exists based on the environment data and the index data structure; and
provide feedback regarding the security vulnerability and the computing policy.

18. The non-transitory machine-readable storage medium of claim 17, wherein the computing policy comprises an Extensible Markup Language (XML) file, and wherein the entry is extracted from the XML file and comprises one or more predetermined threshold configuration values.

19. The non-transitory machine-readable storage medium of claim 17, wherein the index data structure and a prior version of the index data structure are concurrently accessible to the processing device.

20. The non-transitory machine-readable storage medium of claim 17, wherein the feedback comprises a remediation task, a visualization, or an artifact.
